(19) United States
(12) Patent Application Publication
(10) Pub. No.: US 2023/0371681 A1
(43) Pub. Date: Nov. 23, 2023

(54) Self-Cleaning Paintbrush Device

(71) Applicant: Patrick Weaver, Farmville, VA (US)

(72) Inventor: Patrick Weaver, Farmville, VA (US)

(21) Appl. No.: 18/313,549

(22) Filed: May 8, 2023

Related U.S. Application Data
(60) Provisional application No. 63/343,683, filed on May 19, 2022.

(51) Int. Cl. A46B 11/00; A46B 15/00; A46B 17/06; A46D 1/00; B44D 2/00

(52) U.S. Cl. CPC A46B 11/0062; A46B 11/002; A46B 11/0079; A46B 15/0085; A46B 17/06; A46D 1/0207; B44D 2/002; A46B 2200/202

(57) ABSTRACT

The present invention relates to the field of paintbrushes. The device relates to paintbrushes and the use of syringes to dispense paint onto the bristles. The self-cleaning paintbrush device is designed to make painting tasks easier and more efficient by allowing the user to dispense paint directly onto the bristles and to easily clean the brush after use. The device is comprised of a handle, a body, a plurality of bristles, and at least one syringe, as well as various components for attaching the syringe and controlling the flow of paint. The device may be made in a variety of sizes and shapes and may include various indicia on the surface of the body. The bristles may be made from nylon, polyester, or other materials commonly used in paintbrushes.

### CROSS-REFERENCE TO RELATED APPLICATION

The present application claims priority to, and the benefit of, U.S. Provisional Application No. 63/343,683, which was filed on May 19, 2022, and is incorporated herein by reference in its entirety.

### FIELD OF THE INVENTION

The present invention relates generally to the field of paintbrushes. More specifically, the present invention relates to a self-cleaning paintbrush device. The self-cleaning paintbrush device is designed to make painting tasks easier and more efficient by allowing the user to dispense paint directly onto the bristles and to easily clean the brush after use. The device is comprised of a handle, a body, a plurality of bristles, and at least one syringe, as well as various components for attaching the syringe and controlling the flow of paint. Accordingly, the present disclosure makes specific reference thereto. Nonetheless, it is to be appreciated that aspects of the present invention are also equally applicable to other like applications, devices, and methods of manufacture.

### BACKGROUND

Paintbrushes are a common tool used for applying paint to various surfaces, including walls, furniture, and crafts. However, traditional paintbrushes can be difficult to clean and maintain, particularly when using multiple colors or switching between different types of paint. As a result, many painters find it necessary to use multiple brushes for different colors or to constantly stop and clean their brush during a painting project. This can be time consuming and frustrating and can lead to wasted paint as brushes become clogged or dried out. If a paintbrush is not rinsed right after work is completed, paint can cake onto the bristles and become impossible to remove. Applying too much paint to brush bristles can lead to wasted paint and unprofessional painting on different surfaces.

To address these issues, various self-cleaning devices have been developed. These devices typically include a mechanism for flushing out the paint from the bristles, such as a removable reservoir or a built-in pump. However, these devices can be bulky and inconvenient to use, and may not provide a reliable way to evenly distribute paint to the bristles. In addition, some self-cleaning devices can be difficult to clean and maintain, requiring frequent disassembly and cleaning of the various components.

Therefore, there exists a long-felt need in the art for an improved paintbrush. In addition, there exists a long-felt need in the art for a device that is convenient and efficient to use, and that provides a reliable way to evenly distribute paint to the bristles. There is also a long-felt need in the art for a self-cleaning paintbrush device that is easy to clean and maintain. Further, there exists a long-felt need in the art for a self-cleaning paintbrush device that includes features such as a comfortable handle grip, a protective cap or cover, and durable materials. Finally, there is a long-felt need in the art for a self-cleaning paintbrush device that is available in a range of sizes and colors to suit the needs of different users and applications.

The subject matter disclosed and claimed herein, in one embodiment thereof, comprises a self-cleaning paintbrush device. The device is comprised of a handle, a body, a plurality of bristles, and at least one syringe, as well as various components for attaching the syringe and controlling the flow of paint. The self-cleaning paintbrush device is designed to make painting tasks easier and more efficient by allowing the user to dispense paint directly onto the bristles and to easily clean the brush after use. The device may be made in a variety of sizes and shapes and may include various indicia on the surface of the body. The bristles may be made from nylon, polyester, or other materials commonly used in paintbrushes.

In this manner, the self-cleaning paintbrush device of the present invention accomplishes all of the foregoing objectives and provides a novel solution to the long-felt need in the art for an improved paintbrush. The device allows painters to apply paint and clean paintbrushes efficiently and conveniently, saving time and reducing waste. The device also provides a reliable way to evenly distribute paint to the bristles and is easy to clean and maintain. In addition, the device includes features such as a comfortable handle grip, a protective cap or cover, and durable materials, making it an ideal choice for painters of all skill levels and applications. The device is also available in a range of sizes and colors to suit the needs of different users and applications.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a self-cleaning paintbrush device that allows the user to fill the handle with paint to be distributed evenly amongst the bristles to ensure no paint is wasted and allows the user to easily clean the brush via the handle. The self-cleaning paintbrush device is primarily comprised of a handle, a body, a plurality of bristles, and at least one syringe. In the preferred embodiment, the handle may be manufactured from a rigid plastic material. In a differing embodiment, the handle may be manufactured from any type of wood commonly used for making paintbrush handles. In the preferred embodiment, the handle has a hollow center. In this manner, the user is able to administer paint into the handle to be dispensed onto the bristles.

The handle is comprised of at least one dispenser, at least one adapter, at least one tightener, and at least one cap. In the preferred embodiment, the dispenser is fixedly attached to the top outer surface of the handle such that the user can easily press the dispenser. In this manner, the user is able to press the dispenser in order to dispense more paint from the handle onto the bristles. In the preferred embodiment, the dispenser is manufactured from a rigid plastic material. In a differing embodiment, the dispenser may be manufactured from a metal material.

In the preferred embodiment, the adapter is fixedly attached to the handle such that a syringe or a water source can be attached to the adapter to fill or clean the handle. In a differing embodiment, the adapter may be removable. In the preferred embodiment, the adapter is manufactured from a rigid plastic material. In a differing embodiment, the adapter may be manufactured from a metal material.

The tightener is fixedly attached to the adapter such that the user is able to hold the syringe and water source into place by turning the tightener clockwise. In the preferred embodiment, the tightener is made of a metal material. In a differing embodiment, the tightener is manufactured from a rigid plastic material.

In the preferred embodiment, the cap is removable from the handle. In this manner, the user is able to place the cap into the bottom end of the handle in order to keep the paint from leaking out of the handle when in use. In a differing embodiment, the cap may be fixedly attached to the handle to prevent the loss of the cap. The cap is preferably manufactured from a rigid plastic material. In a differing embodiment, the cap may be manufactured from a metal material.

In differing embodiments, the body may have the appearance of a plurality differing shapes, and in the preferred embodiment the body resembles a rectangle. The body may also be manufactured from a plurality of flexible or semi-flexible plastic material that may be commonly used for making paintbrushes but is preferably made of a metal material. The body may also be manufactured in a plurality of sizes to accommodate any paint job. In addition, any surface of the body may be comprised of a plurality of indicia such as patterns, logos, emblems, images, symbols, designs, letters, words, characters, animals, advertisements, brands, etc., that may or may not be paint or paintbrush related.

The body is comprised of an internal canal. In the preferred embodiment, the internal canal is fixedly attached on one end to the top opening of the handle. In this manner, the paint is able to flow from the handle, through the internal canal, and onto the bristles. The internal canal is preferably manufactured from a rigid plastic material. In differing embodiments, the internal canal may be manufactured from a metal material.

The device is also comprised of a syringe. The syringe can be any syringe known in the art that allows the user to insert paint into the handle of the device. In the preferred embodiment, the syringe is manufactured from a rigid plastic material. In a differing embodiment, the syringe may be any object that can inject paint into the handle of the brush.

The bristles are fixedly attached to the body of the device. In this manner, the bristles can take on paint once dispensed from the handle of the device. In the preferred embodiment, the bristles are manufactured from nylon or polyester. In differing embodiments, the bristles may be manufactured from animal hairs.

Accordingly, the self-cleaning paintbrush device of the present invention is particularly advantageous as it provides a novel solution to the long-felt need in the art for an improved paintbrush. The device allows painters to apply paint and clean paintbrushes efficiently and conveniently, saving time and reducing waste. The device also provides a reliable way to evenly distribute paint to the bristles and is easy to clean and maintain. In addition, the device includes features such as a comfortable handle grip, a protective cap or cover, and durable materials, making it an ideal choice for painters of all skill levels and applications. The device is also available in a range of sizes and colors to suit the needs of different users and applications. In this manner, the self-cleaning paintbrush device overcomes the limitations of existing paintbrushes known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a self-cleaning paintbrush device of the present invention in accordance with the disclosed architecture;

FIG. 2 illustrates a side perspective view of one potential embodiment of a self-cleaning paintbrush device of the present invention in accordance with the disclosed architecture; and

FIG. 3 illustrates a side perspective view of one potential embodiment of a self-cleaning paintbrush device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved paintbrush. In addition, there is a long-felt need in the art for a device that is convenient and efficient to use, and that provides a reliable way to evenly distribute paint to the bristles. There is also a long-felt need in the art for a self-cleaning paintbrush device that is easy to clean and maintain. In addition, there exists a long-felt need in the art for a self-cleaning paintbrush device that includes features such as a comfortable handle grip, a protective cap or cover, and durable materials. Further, there is a long-felt need in the art for a self-cleaning paintbrush device that is available in a range of sizes and colors to suit the needs of different users and applications.

The present invention, in one exemplary embodiment, is comprised of a self-cleaning paintbrush device that is primarily comprised of a handle, a body, a plurality of bristles, and at least one syringe. In the preferred embodiment, the handle may be manufactured from a rigid plastic material. In a differing embodiment, the handle may be manufactured from any type of wood commonly used for making paintbrush handles. In the preferred embodiment, the handle has a hollow center. In this manner, the user is able to administer paint into the handle to be dispensed onto the bristles.

The handle is comprised of at least one dispenser, at least one adapter, at least one tightener, and at least one cap. In the preferred embodiment, the dispenser is fixedly attached to the top outer surface of the handle such that the user can easily press the dispenser. In this manner, the user is able to press the dispenser in order to dispense more paint from the handle onto the bristles. In the preferred embodiment, the dispenser is manufactured from a rigid plastic material. In a differing embodiment, the dispenser may be manufactured from a metal material.

In the preferred embodiment, the adapter is fixedly attached to the handle such that a syringe or a water source can be attached to the adapter to fill or clean the handle. In a differing embodiment, the adapter may be removable. In the preferred embodiment, the adapter is manufactured from a rigid plastic material. In a differing embodiment, the adapter may be manufactured from a metal material.

The tightener is fixedly attached to the adapter such that the user is able to hold the syringe and water source into place by turning the tightener clockwise. In the preferred embodiment, the tightener is made of a metal material. In a differing embodiment, the tightener is manufactured from a rigid plastic material.

In the preferred embodiment, the cap is removable from the handle. In this manner, the user is able to place the cap into the bottom end of the handle in order to keep the paint from leaking out of the handle when in use. In a differing embodiment, the cap may be fixedly attached to the handle to prevent the loss of the cap. The cap is preferably manufactured from a rigid plastic material. In a differing embodiment, the cap may be manufactured from a metal material.

In differing embodiments, the body may have the appearance of a plurality differing shapes, and in the preferred embodiment the body resembles a rectangle. The body may also be manufactured from a plurality of flexible or semi-flexible plastic material that may be commonly used for making paintbrushes but is preferably made of a metal material. The body may also be manufactured in a plurality of sizes to accommodate any paint job. In addition, any surface of the body may be comprised of a plurality of indicia such as patterns, logos, emblems, images, symbols, designs, letters, words, characters, animals, advertisements, brands, etc., that may or may not be paint or paintbrush related.

The device is also comprised of a syringe. The syringe can be any syringe known in the art that allows the user to insert paint into the handle of the device. In the preferred embodiment, the syringe is manufactured from a rigid plastic material. In a differing embodiment, the syringe may be any object that can inject paint into the handle of the brush.

The bristles are fixedly attached to the body of the device. In this manner, the bristles can take on paint once dispensed from the handle of the device. In the preferred embodiment, the bristles are manufactured from nylon or polyester. In differing embodiments, the bristles may be manufactured from animal hairs.

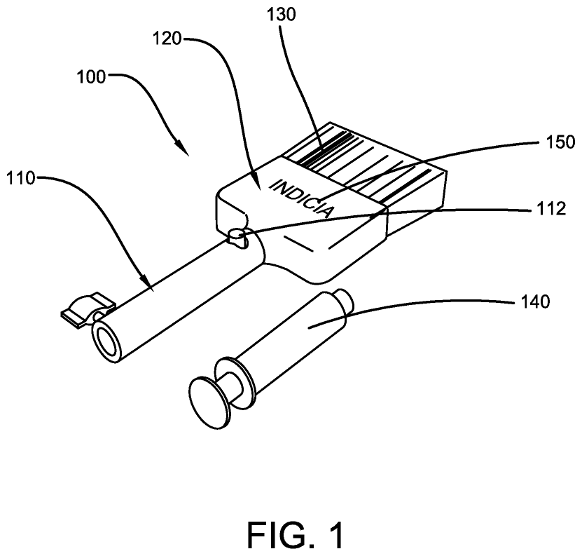

Referring initially to the drawings, FIG. 1 illustrates a front perspective view of one potential embodiment of a self-cleaning paintbrush device 100 of the present invention in accordance with the disclosed architecture. The device 100 that is primarily comprised of a handle 110, a body 120, a plurality of bristles 130, and at least one syringe 140. In the preferred embodiment, the handle 110 may be manufactured from a rigid plastic material such as but not limited to acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. In a differing embodiment, the handle 110 may be manufactured from any type of wood commonly used for making paintbrush handles such as, but not limited to, beechwood, birchwood, cherrywood, ebony, mahogany, maple, oak, rosewood, walnut, willowwood, etc. In a differing embodiment, the handle 110 may have grip manufactured from a non-slip rubber material such as, but not limited to, neoprene, silicone, nitrile, EPDM, styrene-butadiene, butyl, natural, fluorosilicone, natural rubbers, neoprene rubber elastomer, silicone rubber elastomer, ethylene propylene diene monomer rubber, butyl rubber, nitrile rubber, buna-n rubber, styrene-butadiene rubber elastomers, viton rubber elastomer, diaphragm rubber, thermoplastic rubber, etc. In the preferred embodiment, the handle 110 has a hollow center. In this manner, the user is able to fill the handle 110 with paint to be dispensed onto the bristles 130.

In the preferred embodiment, the dispenser 112 is in the form of a button attached to the top outer surface of the handle 110 such that the user can easily press the dispenser 112. In this manner, the user is able to press the dispenser 112 in order to dispense more paint from the handle 110 onto the bristles 130. In the preferred embodiment, the dispenser 112 is manufactured from a rigid plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. In a differing embodiment, the dispenser 112 may be manufactured from a metal material.

In differing embodiments, the body 120 may have the appearance of a plurality differing shapes such as, but not limited to, a square, a circle, an oval, a triangle, a hexagon, a pentagon, etc., and in the preferred embodiment the body 120 resembles a rectangle. The body 120 may also be manufactured from a plurality of flexible or semi-flexible plastic material that may be commonly used for making paintbrushes but is preferably made of a metal material. The body 120 may also be manufactured in a plurality of sizes to accommodate any paint job such as, but not limited to, small, medium, large, extra-large, etc. In addition, any surface of the body 120 may be comprised of a plurality of indicia 150 such as patterns, logos, emblems, images, symbols, designs, letters, words, characters, animals, advertisements, brands, etc., that may or may not be paint or paintbrush related.

The device is also comprised of a syringe 140. The syringe 140 can be any syringe known in the art that allows the user to inject paint into the handle 110 of the device 100. In the preferred embodiment, the syringe 140 is manufactured from a rigid plastic material such as but not limited to acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. In a differing embodiment, the syringe 140 may be any object that can inject paint into the handle 110 of the device 100.

The bristles 130 are fixedly attached to the body 120 of the device 100. In this manner, the bristles 130 can take on paint once dispensed from the handle 110 of the device 100. In the preferred embodiment, the bristles 130 are manufactured from nylon or polyester. In differing embodiments, the bristles 130 may be manufactured from animal hairs such as, but not limited to, hog bristle, sable hair, squirrel hair, goat hair, animal hair, synthetic animal hair, etc.

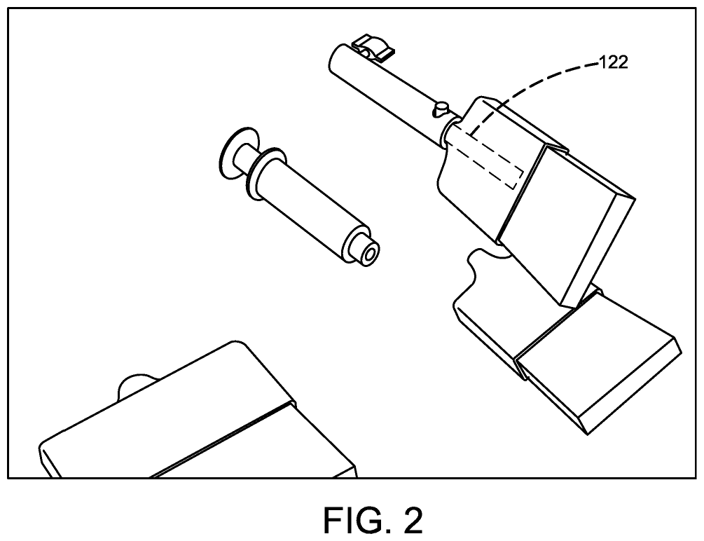

FIG. 2 illustrates a side perspective view of one potential embodiment of a self-cleaning paintbrush device 100 of the present invention in accordance with the disclosed architecture. The body 120 is comprised of at least one internal canal 122. In the preferred embodiment, the internal canal 122 is fixedly attached on one end to the top opening of the handle 110. In this manner, the paint is able to flow from the handle 110, through the internal canal 122, and onto the bristles 130.

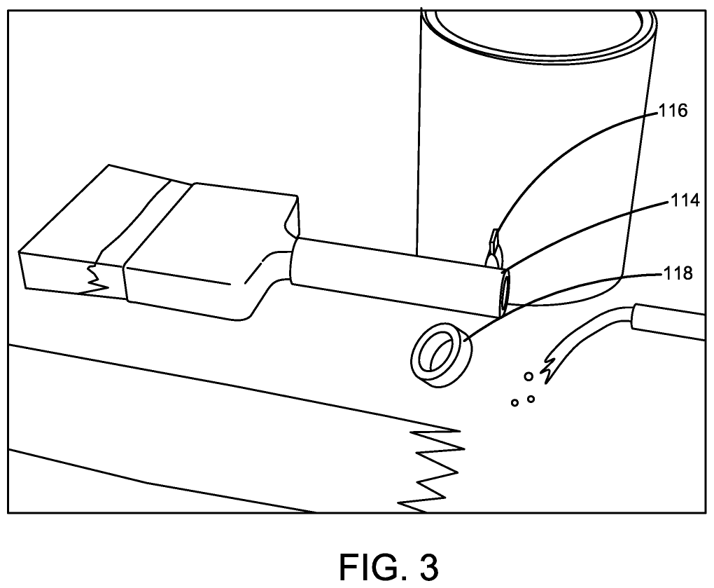

FIG. 3 illustrates a side perspective view of one potential embodiment of a self-cleaning paintbrush device 100 of the present invention in accordance with the disclosed architecture. The handle 110 is comprised of at least one dispenser 112, at least one adapter 114, at least one tightener 116, and at least one cap 118. In the preferred embodiment, the adapter 114 is fixedly attached to the handle 110 such that the syringe 140 or a water source can be attached to the adapter 114 to fill or clean the handle 110. In a differing embodiment, the adapter 114 may be removable. The tightener 116 is a rotating fastener fixedly attached to the adapter 114 such that the user is able to hold the syringe 140 and water source into place by turning the tightener 116 clockwise.

In the preferred embodiment, the cap 118 is removable from the handle 110. In this manner, the user is able to place the cap 118 into the bottom end of the handle 110 in order to keep the paint from leaking out of the handle 110 when in use. In a differing embodiment, the cap 118 may be fixedly attached to the handle 110 to prevent the loss of the cap 118.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “self-cleaning paintbrush device” and “device” are interchangeable and refer to the self-cleaning paintbrush device 100 of the present invention.

Notwithstanding the foregoing, the self-cleaning paintbrush device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the self-cleaning paintbrush device 100 as shown in the FIGS. are for illustrative purposes only, and that many other sizes and shapes of the self-cleaning paintbrush device 100 are well within the scope of the present disclosure. Although the dimensions of the self-cleaning paintbrush device 100 are important design parameters for user convenience, the self-cleaning paintbrush device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A self-cleaning paintbrush device comprising:
a handle;
a bristle;
an internal canal;
a tightener;
a dispenser; and
a syringe.

2. The self-cleaning paintbrush device of claim 1, wherein the handle is comprised of a plastic material.

3. The self-cleaning paintbrush device of claim 1, wherein the handle is hollow.

4. The self-cleaning paintbrush device of claim 1, wherein the dispenser is comprised of a button.

5. The self-cleaning paintbrush device of claim 4, wherein the button is positioned on the handle.

6. A self-cleaning paintbrush device comprising:
a handle;
a bristle;
an internal canal;
a tightener;
a cap;
a dispenser; and
a syringe.

7. The self-cleaning paintbrush device of claim 6, wherein the handle is comprised of a wood material.

8. The self-cleaning paintbrush device of claim 6, wherein the handle is hollow.

9. The self-cleaning paintbrush device of claim 6, wherein the tightener is comprised of a rotating fastener.

10. The self-cleaning paintbrush device of claim 6, wherein the bristle is comprised of a nylon or a polyester material.

11. A self-cleaning paintbrush device comprising:
a hollow handle;
a bristle;
an internal canal;
a tightener;
a cap;
an adapter;
a button; and
a syringe.

12. The self-cleaning paintbrush device of claim 11, wherein the bristle is comprised of an animal hair.

13. The self-cleaning paintbrush device of claim 11, wherein the bristle is comprised of a synthetic material.

14. The self-cleaning paintbrush device of claim 11, wherein the internal canal is in fluid communication with the hollow handle.

15. The self-cleaning paintbrush device of claim 11, wherein the end cap attaches to the hollow handle.

16. The self-cleaning paintbrush device of claim 11, wherein the tightener is positioned on the adapter.

17. The self-cleaning paintbrush device of claim 11, wherein the adapter is sized and configured to receive the syringe.

18. The self-cleaning paintbrush device of claim 11, wherein the hollow handle is comprised of a metal material.

19. The self-cleaning paintbrush device of claim 11, wherein the cap is fixedly attached to the hollow handle.

20. The self-cleaning paintbrush device of claim 11 further comprised of an indicia.
